(19) United States
(12) Patent Application Publication
(10) Pub. No.: US 2004/0010562 A1
(43) Pub. Date: Jan. 15, 2004

(54) Shared cache server

(76) Inventor: Wataru Itonaga, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/602,680

(22) Filed: Jun. 25, 2003

(30) Foreign Application Priority Data
Jun. 26, 2002 (JP) 2002-186618

(51) Int. Cl. G06F 15/167

(52) U.S. Cl. 709/213

(57) ABSTRACT

A shared cache server which is capable of being shared among groups in a common network in which a plurality of groups is placed in a virtually partitioned manner. A storage device stores contents in each of a plurality of storage areas corresponding to a plurality of groups. Virtual interfaces are placed in a manner so as to correspond to a plurality of virtual networks. An address converting function section, when receiving a packet requiring for contents through the virtual interface from a client, converts part of an IP (Internet Protocol) of the packet to an internal address corresponding to the virtual interface. A cache function section, based on the internal address converted by the address converting function section, reads contents of a corresponding group from a storage area of the storage device.

### BACKGROUND OF THE INVENTION

1. Field of the Invention

The present invention relates to a shared cache server and more particularly to the cache server being commonly shared among a plurality of virtual networks.

The present application claims priority of Japanese Patent Application No. 2002-186618 filed on Jun. 26, 2002, which is hereby incorporated by reference.

2. Description of the Related Art

A cache server is used to store contents and transmits contents to a client having requested delivery of contents to the client. There are two types of cache servers, one temporarily storing contents requested by the client and another storing contents only during a period designated by a contents manager. Hereinafter, both cache servers are simply and collectively called a “cache server” without distinction of the type.

In recent years, as an access network of a broad-band type is widely used, a CDN (Content Delivery Network) with an aim of effectively delivering contents has received attention. In the CDN, cache servers storing same contents are placed in a plurality of positions on a network. When a client accesses contents, a cache server placed in a position being nearest to the client is selected out of a plurality of cache servers and contents are delivered from the selected cache server. As a result, a high-speed response to the client is made possible.

On the other hand, another technology has also received attention which constructs a plurality of VPNs (Virtual Private Networks) on a network being commonly used by MPLS (Multi Protocol Label Switching) technology and according to IEEE 802. 1Q (VLAN tag format), or a like. By using this technology, each group, since components making up a distributed network are connected through a common network can achieve a wide area network at low costs. On the common network, traffic of each group or a like is in a virtually partitioned manner and each group can construct a closed network for every group, the network can be used as if the network were to be constructed by a private line.

In the network where the VPN is constructed on such the common network as described above, each group, when constructing the CDN on the network, has to mount a cache server, as its own individual device, in components making up a network of each group outside the common network. This presents problems that each group has to bear increased costs in placing the cache server and/or that additional space is required for setting up the cache server.

A provider of the common network, instead of each group, can construct the cache server on the common network. However, even in this case, since a network of each group is placed in a virtually partitioned manner, on the common network, the provider of the common network has to construct the cache server for every group. Conventionally, when a plurality of networks each being placed in a virtually partitioned manner on a network is constructed, the cache server that can singly store contents corresponding to the plurality of groups is not known.

### SUMMARY OF THE INVENTION

In view of the above, it is an object of the present invention to provide a shared cache server which is placed on a common network in which a plurality of networks each being placed in a virtually partitioned manner and which is capable of being shared among a plurality of groups.

According to a first aspect of the present invention, there is provided a shared cache server being placed on a common network in which a plurality of virtual networks each being placed in a virtually partitioned manner is constructed corresponding to a plurality of groups, including:

a storage device to store contents in each of a plurality of storage areas corresponding to the plurality of groups;

a plurality of virtual interfaces being placed in a manner to correspond to the plurality of virtual networks;

an address converting function section, when receiving a packet requesting for contents with a Uniform Resource Locator (URL) designated through one of the virtual interfaces, converts part of an Internet Protocol (IP) address contained in the packet to an internal address corresponding to a virtual interface having received the packet; and

a cache function section, based on an internal address converted by the address converting function section, reads contents from a storage area of the storage device.

In the foregoing, a preferable one is that wherein includes a tag inserting and withdrawing function section to convert the internal address to a tag corresponding to the group and to insert the tag into the URL and wherein the cache function section designates contents based on the URL into which the tag is inserted.

Also, a preferable mode is one wherein the tag inserting and withdrawing function section converts, for a packet with a specified URL designated, the internal address to a specified tag being used commonly in the group.

Also, a preferable mode is one that wherein includes a storage capacity managing function section to manage storage capacity in a storage area in every the group.

Also, a preferable mode is one that wherein the storage capacity managing function section dynamically manages the storage area in every the group.

Also, a preferable mode is one that wherein includes a Domain Name System (DNS) proxy function section to designate a server in which contents are stored when contents designated by the packet are not stored in the storage device.

Also, a preferable mode is one wherein the plurality of virtual networks each being placed in a virtually partitioned manner is constructed in accordance with IEEA 802. 1Q.

Also, a preferable mode is one wherein the plurality of virtual networks each being placed in a virtually partitioned manner is constructed in accordance with MPLS technology.

According to a second aspect of the present invention, there is provided a shared cache server being placed on a common network connected to a plurality of groups each having an IP address range to be used being different from one another, including:

a storage device to store contents in each of a plurality of storage areas corresponding to the plurality of groups; and

a cache function section to convert, when receiving a packet requesting for contents with a URL designated, part of an IP address contained in the packet to a tag corresponding to the group and to insert the tag into the URL and to read contents from a storage area of the storage device based on the URL into which the tag has been inserted.

With the above configurations, in a common network in which a plurality of groups is placed in a virtually partitioned manner therein, the shared cache server of the present invention judges to which group a client belongs by a virtual interface having received a packet requesting contents transmitted from a client. Therefore, it is made possible to share one cache server and it is not necessary to place a cache server for every group.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing connection of a common network in which a shared cache server of an embodiment of the present invention is used;

FIG. 2 is a schematic block diagram showing configurations of the shared cache server of the embodiment of the present invention;

FIG. 3 is a flowchart showing an example of operations of the shared cache server in FIG. 2; and

FIG. 4 is a block diagram illustrating an IP address obtained after conversion in the present invention.

### DETAILED DESCRIPTION OF THE PREFERRED EMBODIMENTS

Best modes of carrying out the present invention will be described in further detail using various embodiments with reference to the accompanying drawings.

### Embodiment

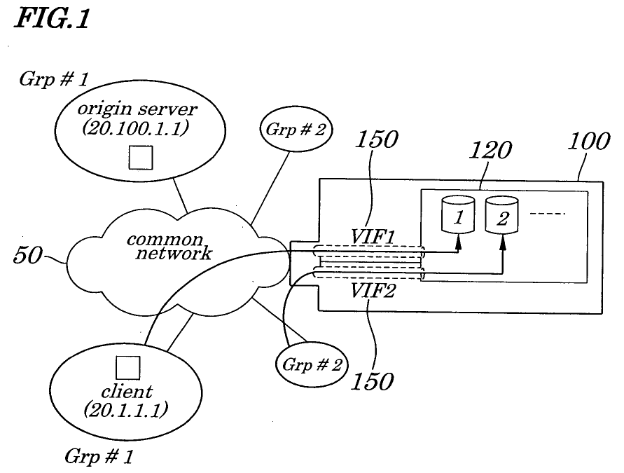

FIG. 1 is a schematic block diagram showing connection of a common network 50 in which a shared cache server 100 of an embodiment of the present invention is used. The common network 50 has the shared cache server 100 and provides a virtual private network VPN to one group Grp#1 and another group Grp#2.

The common network 50 is constructed by using Multi Protocol Label Switching (MPLS) technology and according to IEEE 802. 1Q (VLAN tag format). A network made up of the group Grp#1 and a network made up of the group Grp#2 are placed in a virtually partitioned manner. The shared cache server 100 caches a contents corresponding to each of the groups Grp #1 and Grp #2.

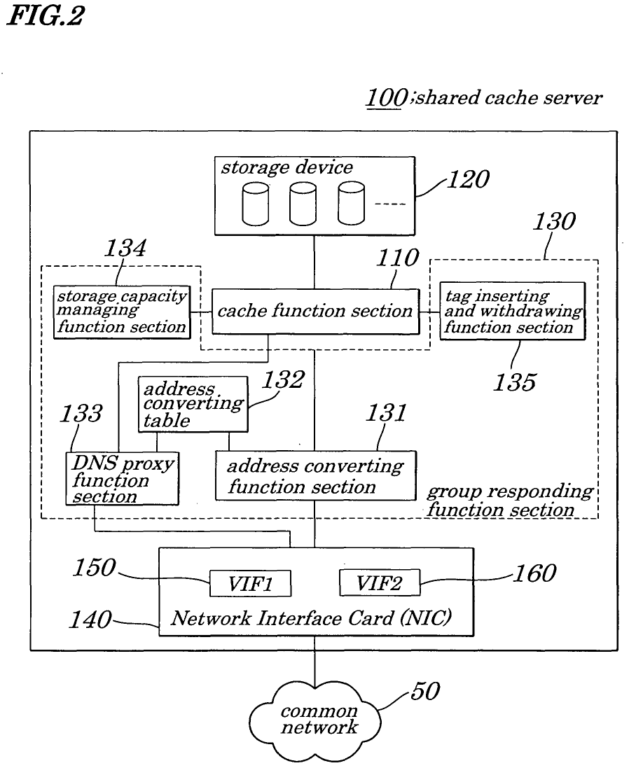

FIG. 2 is a schematic block diagram showing configurations of the shared cache server 100 of the embodiment of the present invention. The shared cache server 100 has a cache function section 110, a storage device 120, a group responding function section 130, and a Network Interface Card (NIC) 140. The group responding function section 130 includes an address converting function section 131, an address converting table 132, a Domain Name System (DNS) proxy function section 133, a storage capacity managing function section 134, and a tag inserting and withdrawing function section 135. The Network Interface Card (NIC) 140 has a virtual interface (VIF1) 150 and a virtual interface (VIF2) 160.

The Network Interface Card (NIC) 140 is connected to the common network 50. The shared cache server 100 receives a packet through the virtual interface (VIF1) 150 from the group Grp#1 and a packet through the virtual interface (VIF2) 160 from the group Grp#2. The group responding function section 130 performs a process in a manner so as to correspond to each group. The storage device 120 whose entire storage capacity is partitioned in a virtual manner and in a manner so as to correspond to each group stores contents corresponding to each group into a partitioned storage capacity corresponding to each group. As the storage device 120, a magnetic storage medium such as a hard disk or a like, or an optical storage medium such as a CD-R (Compact Disk Recordable) or a like is used. The cache function section 110, based on a URL into which a tag has been inserted, performs a search for contents in the storage device 120 and extracts contents from the storage device 120 or stores contents into the storage device 120.

The address converting function section 131 has a function obtained by extending a NAT (Network Address Translator) function and converts an IP address being used on a side of the common network 50 to an IP address corresponding to each group and being used by the cache function section 110 and vice versa. The conversion of an IP address is performed based on correspondence between a high-order “n” bit of an IP address being used by each group and the cache function section 110.

The address converting table 132 stores correspondence of an IP address obtained before and after the conversion in the address converting function section 131. The Domain Name System (DNS) proxy function section 133 selects a DNS server corresponding to each group. The storage capacity managing function section 134 manages partitioned capacity being allocated to each group in the storage device 120 and capacity being presently used in each group using a table. The tag inserting and withdrawing function section 135 inserts a tag corresponding to each group into the URL or withdraws a tag from the URL.

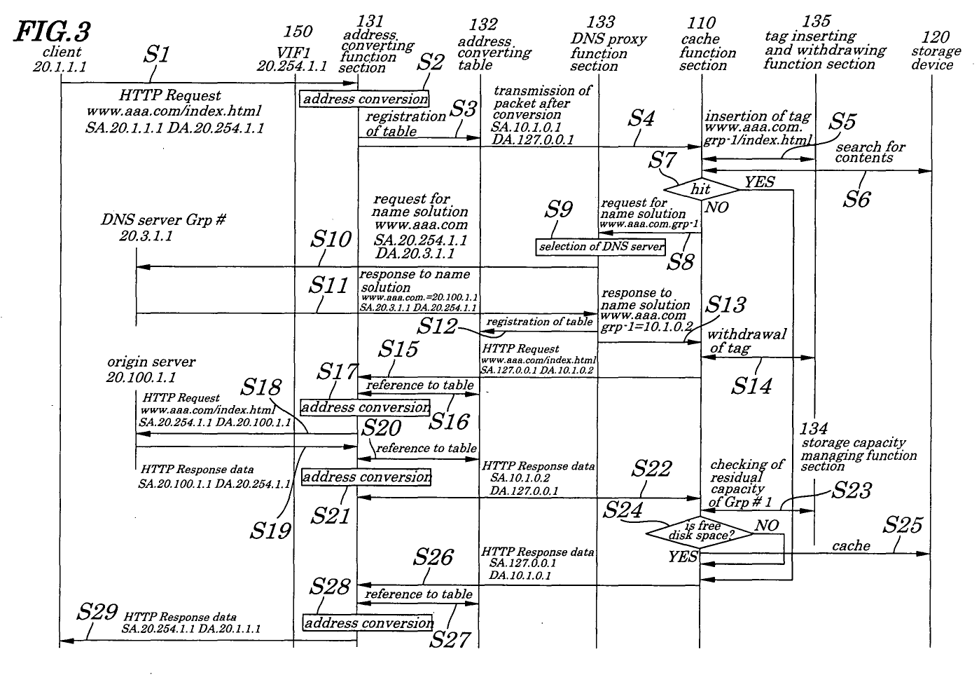

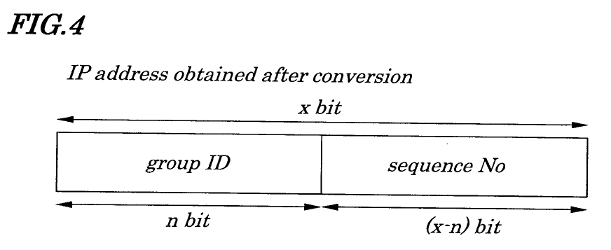

FIG. 3 is a flowchart showing an example of operations of the shared cache server 100 in FIG. 2. FIG. 4 is ablock diagram illustrating an IP address obtained after conversion in the present invention. Operations of the shared cache server 100 to be performed, for example, when a client belonging to the group Grp#1 makes a request for delivery of contents are described below.

A client (transmitter IP address: SA 20.1.1.1) belonging to a group Grp#1, by designating a URL (http://www.aaa.com/index.html) requests the shared cache server 100 (destination IP address: DA 20.254.1.1) to deliver contents (Step S1). A request packet from the client is received through the virtual interface (VIF1) 150 corresponding to the group Grp#1 in the Network Interface Card (NIC) 140 by the address converting function section 131.

The address converting function section 131 converts a transmitter IP address, a destination IP address, or a like being contained in the request packet to an IP address to be used in the cache function section 110 (Step S2). The conversion of an IP address in the address converting function section 131 is made based on a table shown below which associates a group with high-order “n” bits of an IP address obtained after the conversion, a Sequence No. being in use which is employed to manage a sequence number presently in use.

TABLE 1

| VIF | Group ID | Seq. No. in use |
|---|---|---|
| VIF1 | 10.1/n = 16(bit) | 1, . . . 53, . . . 932 |
| VIF2 | 10.2/n = 16(bit) | 1, . . . 877, . . . 1156 |

That is, as shown in FIG. 4, the address converting function section 131, converts high-order “n” bits of an IP address (32 bits in IPv4 and 128 bits in IPv6) to a value represented by a group ID and a remaining low-order (x−n) bits to a not-used sequence number being not overlapped by a value being represented by Seq. No. in use in Table 1.

An IP address obtained before and after being converted by the address converting function section 131 is stored in the address converting table 132 with an IP address (obtained before the conversion) being used on a side of the common network 50 associated with an IP address (obtained after the conversion) being used by the cache function section 110 in a form of a table having information as shown below (Step S3).

TABLE 2

| | before the conversion | | | | | after the conversion | | | |
|---|---|---|---|---|---|---|---|---|---|
| | SA | DA | SP | DP | VIF | SA | DP | SP | DP |
| 1 | 20.1.1.1 | 20.254.1.1 | 1981 | 80 | 1 | 10.1.0.1 | 127.0.0.1 | 1981 | 8080 |
| 2 | 20.100.1.1. | 20.254.1.1 | 80 | 8901 | 1 | 10.1.0.2 | 127.0.0.1 | 80 | 2001 |

In the above table, “SP” and “DP” show port numbers respectively. In the example in Table 2, DA (20.254.1.1) being an IP address of the shared cache server 100 is converted to an address DP (127.0.0.1) of a local interface that the shared cache server 100 has.

The cache function section 110 receives a request packet whose IP address or a like has been converted by the address converting function section 131 (Step S4).

The cache function section 110 transmits a URL (www.aaa.com/index.html) contained in the request packet and the converted SA (10.1.0.1) to the tag inserting and withdrawing function section 135 and the tag inserting and withdrawing function section 135 inserts a group tag into the URL according to the following table (Step S5).

TABLE 3

| Group ID | Group tag |
|---|---|
| 10.1/N = 16 bit | grp-1 |
| 10.2/N = 16 bit | grp-2 |

In the example shown in FIG. 3, the tag inserting and withdrawing function section 135, by referring to high-order 16 bits (10.1) of the converted SA (10.1.0.1), produces a URL (www. aaa. com. grp-1/index. html) into which the corresponding group tag (grp-1) has been inserted.

The cache function section 110, based on the URL into which the group tag has been inserted, performs a search for contents in the storage device 120 (Step S6) and judges whether or not contents requested by the client are stored as contents of the group corresponding to the group tag in the storage device 120 (Step S7). When contents are judged to be stored (that is, a hit is found in the cache), a routine proceeds to Step S22 where contents extracted from the storage device 120 are transmitted to the client. If contents are judged not to be stored (that is, a mishit is found in the cache) in Step S7, the routine proceeds to a process in which contents are acquired from an origin server storing contents.

When a mishit is found in the cache, the Domain Name System (DNS) proxy function section 133 receives, as a name solution request, a URL into which a group tag has been inserted, from the cache function section 110 (Step S8). The DNS proxy function section 133 has a table as shown below and selects, based on a group tag contained in an FQDN (Fully Qualified Domain Name) (www. aaa. com. grp-1), a DNS server which stores a URL (origin server name) and an IP address of the origin server in such a manner the URL (origin server name) and the IP address of the origin server is associated with each other (Step S9).

TABLE 4

| Group tag | DNS server |
|---|---|
| grp-1 | 20.3.1.1 |
| grp-2 | 43.1.1.1 |

When the DNS server is selected, a name solution request of the FQDN (www. aaa.com.) is transmitted through the virtual interface (VIF1) 150 corresponding to the group Grp#1 (Step S10). The DNS proxy function section 133 acquires an IP address (20.100.1.1) of the origin server which is transmitted from the DNS server (Step S11). The DNS proxy function section 133, by referring to Table 1, acquires a group ID and a not-used sequence number, and adds such the table as shown in Table 2 to the address converting table 132 to be used to convert the IP address of the origin server to the IP address corresponding to the group that the cache function section 110 uses (Step S12). The IP address of the origin server obtained after the conversion is transmitted to the cache function section 110 as a name solution response (Step S13).

The cache function section 110 transmits a URL into which a tag has been inserted to the tag inserting and withdrawing function section 135 and receives a URL from which a tag has been deleted (Step S14) and then, in order to acquire contents from the origin server, designates an IP address (DA 10.1.0.2) of the converted origin server or a URL (www.aaa.com/index. html) from which a tag has been deleted and transmits a HTTP (Hyper Text Transfer Protocol) Request signal (Step S15). The address converting function section 131, by referring to the address converting table 132 (Step S16), converts an IP address contained in a packet to be transmitted to the origin server (Step S17). A packet whose IP address or a like has been converted is transmitted through the virtual interface (VIF1) 150 corresponding to the group Grp#1 to the origin server (Step S18).

The origin server transmits a response containing contents represented by a URL as HTTP Response Data to the shared cache server 100 (Step S19). A packet transmitted from the origin server is transmitted through the virtual interface (VIF1) 150 corresponding to the group Grp#1 to the address converting function section 131. The address converting function section 131 converts an IP address or a like being contained in a received packet, in a direction reverse to that in Step S17 (Step S21), by referring to the address converting table 132 (Step S20). A packet whose IP address or a like has been converted by the address converting function section 131 is transmitted to the cache function section 110 (Step S22).

The cache function section 110 inquires of the storage capacity managing function section 134 whether or not contents to be received from the origin server can be stored in the storage device 120 (Step S23). The storage capacity managing function section 134 compares capacity of contents to be received from the origin server with storage capacity assigned to the corresponding group in the storage device 120. The cache function section 110 receives an information signal as to whether or not the storage device 120 has available disk space for the corresponding group and determines whether or not contents are stored (Step S24). If the storage device 120 has available disk space for the corresponding group, received contents are stored in the storage device 120 (Step S25). If there is no free disk space for the corresponding group, contents are not stored and are distributed to a client.

In the process of distributing contents, contents extracted from the storage device 120 in Step S6 or contents that the cache function section 110 has received in Step S22 are transmitted, after an IP address (DA 10.1.0.1) of a client has been designated, from the cache function section 110 (Step S26). The address converting function section 131, by referring to the address converting table 132 (Step S27), converts an IP address of a client or a like to an IP address or a like to be used in the common network 50 (Step S28). Contents that a client has requested to be distributed are transmitted through the virtual interface (VIF1) 150 corresponding to the group Grp#1 to the client (Step S29).

In the embodiment, what group the client belongs to is judged depending on whether a packet requesting for contents transmitted from the client has been received through the virtual interface (VIF1) 150 or through the VIRTUAL INTERFACE (VIF2) 160. The cache function section 110 manages contents by using a URL into which a tag used to identify a group has been inserted and extracts contents from the storage device 120 being partitioned in a manner so as to respond to a group to which the client belongs and in a virtual manner, or adds contents to the storage device 120.

The storage device 120 can be partitioned in a manner so as to correspond to a group and in a virtual manner by storing with contents designated by a URL being associated with the URL into which a tag has been inserted. Therefore, even if a request for distributing contents is made by clients belonging to the groups Grp #1 and Grp#2 with a same URL being designated, the cache function section 110 manages the contents requested for the distribution as contents of a different URL into which a tag has been inserted and does not extract contents that have been stored for a different group from the storage device 120. As a result, even when a plurality of networks being placed in a virtually partitioned manner is constructed on the common network 50, by the shared cache server 100 in which a plurality of cache servers is placed in a virtual manner without placing a cache server for every group, contents that can correspond to a plurality of groups can be accumulated. Moreover, since the shared cache server 100 manages a cache with inserting a tag into a URL, change to be added to an existing cache server is little and costs for placing additional cache servers are not required.

In the above embodiment, an example is shown in which the common network 50, as a network using the shared cache server 100, is placed in a virtually partitioned manner for every group, however, instead of this or in addition to this, the common network 50, by using an IP address within a range distinguishable from each other, that can identify a group can be employed. In this case, for example, the group Grp#1 uses an IP address whose high-order 16 bits begin with 133.10 and the group Grp#2 uses an IP address whose high-order 16 bits begin with 133.20.

In the above case, the shared cache server 100 judges as to which group a client having requested contents to be distributed belongs, by using high-order 16 bits of an IP address of the client. The tag inserting and withdrawing function section 135, instead of inserting a group tag based on an IP address obtained by conversion of the address converting function section 131, inserts a corresponding group tag based on high-order “n” bits having received from a client. This enables proper judgement as to what group the client requesting contents to be distributed belongs to and allows selection of the storage device 120 having been partitioned in a virtual manner in which a search is made and/or in which contents are stored.

Moreover, in the above embodiment, an example is shown in which a cache server is placed in a virtual manner for every group and, if contents requested by a group are not stored for the group, the contents are not extracted from the storage device 120. However, the shared cache server 100 may have a cache server that can be commonly used among groups in a virtual manner. In this case, the storage device 120 is partitioned in a virtual manner into several portions, a plurality of storage regions allocated for every group and a common storage region to be used commonly among groups.

Each group sets conditions and/or makes a contract about sharing of contents in advance and sets a URL of shared contents to the shared cache server 100. The tag inserting and withdrawing function section 135, when a URL into which a tag has to be inserted is a URL in which contents are shared, inserts a tag for shared use, instead of a group tag. The contents into which the tag for shared use are stored in the storage device 120 which is used commonly in each group. By configuring as above, contents can be shared among groups.

If contents are shared among groups, limitation may be imposed on groups that share the contents. For example, if contents A are shared between the groups Grp#1 and Grp#2 and contents B are shared between groups Grp#1 and Grp#3, a URL of contents to be shared and information about groups sharing the contents are set to the shared cache server 100. The tag inserting and withdrawing function section 135, when a URL into which a tag has to be inserted is a URL being set so that contents are shared and a client having requested for contents belongs to a group being set so that contents are shared, a tag for shared use is inserted instead of a group tag. By configuring as above, limitation may be imposed on groups sharing the contents.

Functions of the shared cache server 100 can be partitioned into, for example, two portions, one having group responding function and another having cache function, that is, the group responding function section 130 and the cache function section 110 may be constructed as a separate device. In the storage device 120, its storage capacity may be assigned in a fixed manner for every group or in a dynamic manner. When its storage capacity is assigned dynamically, storage capacity of the storage device 120 can be effectively used. For example, if all storage capacity of the storage device 120 is 10 G bytes, 5 G bytes are set, as a minimum ensured capacity, to the group Grp#1 and group Grp#2 respectively, and the group Grp#1 and Grp#2 store contents having up to 5 G bytes capacity with priority. In this case, when capacity that the group Grp#2 uses is less than 5 G bytes, the group Grp#1 can store contents having capacity exceeding 5 G bytes. When the group Grp#2 has to store new contents, contents of the group Grp#1 being equivalent to contents having capacity exceeding 5 G bytes are deleted in order to ensure capacity that the group Grp#2 uses.

It is apparent that the present invention is not limited to the above embodiments but may be changed and modified without departing from the scope and spirit of the invention. For example, a protocol to be cached by a shared cache server is not limited to the HTTP and may be a protocol of a stream. A plurality of groups is not limited to two groups.

What is claimed is:

1. A shared cache server being placed on a common network in which a plurality of virtual networks each being placed in a virtually partitioned manner is constructed corresponding to a plurality of groups, comprising:
a storage device to store contents in each of a plurality of storage areas allocated corresponding to said plurality of groups;
a plurality of virtual interfaces being placed in a manner to correspond to said plurality of virtual networks;
an address converting function section, when receiving a packet requesting for contents with a Uniform Resource Locator (URL) designated through one of said virtual interfaces, converts part of an Internet Protocol (IP) address contained in said packet to an internal address corresponding to a virtual interface having received said packet; and
a cache function section, based on an internal address converted by said address converting function section, reads contents from a corresponding storage area of said storage device.

2. The shared cache server according to claim 1, further comprising a tag inserting function section to convert said internal address to a tag corresponding to said group and to insert said tag into said Uniform Resource Locator and wherein said cache function section designates contents based on said Uniform Resource Locator into which said tag is inserted.

3. The shared cache server according to claim 2, wherein said tag inserting function section converts, for a packet with a specified Uniform Resource Locator designated, said internal address to a specified tag being used commonly in said group.

4. The shared cache server according to claim 1, further comprising a storage capacity managing function section to manage storage capacity in a storage area in every said group.

5. The shared cache server according to claim 4, wherein said storage capacity managing function section dynamically manages said storage area in every said group.

6. The shared cache server according to claim 1, further comprising a Domain Name System (DNS) proxy function section to designate a server in which contents are stored when contents designated by said packet are not stored in said storage device.

7. The shared cache server according to claim 1, wherein said plurality of virtual networks each being placed in a partitioned and virtual manner is constructed in accordance with IEEA 802. 1 Q.

8. The shared cache server according to claim 1, wherein said plurality of virtual networks each being placed in a virtually partitioned manner is constructed in accordance with MPLS Multi Protocol Label Switching (MPLS) technology.

9. A shared cache server being placed on a common network connected to a plurality of groups each having an Internet Protocol address range to be used being different from one another, comprising:
a storage device to store contents in each of a plurality of storage areas corresponding to said plurality of groups; and
a cache function section to convert, when receiving a packet requesting for contents with a Uniform Resource Locator (URL) designated, part of an Internet Protocol (IP) address contained in said packet to a tag corresponding to said group and to insert said tag into said Uniform Resource Locator (URL) and to read contents from a storage area of said storage device based on said Uniform Resource Locator (URL) into which said tag has been inserted.

10. A shared cache server being placed on a common network in which a plurality of virtual networks each being placed in a virtually partitioned manner is constructed corresponding to a plurality of groups, comprising:
a storage device to store contents in each of a plurality of storage areas allocated corresponding to said plurality of groups;
a plurality of virtual interfaces being placed in a manner to correspond to said plurality of virtual networks;
an address converting means, when receiving a packet requesting for contents with a Uniform Resource Locator (URL) designated through one of said virtual interfaces, converts part of an Internet Protocol (IP) address contained in said packet to an internal address corresponding to a virtual interface having received said packet; and
a cache means, based on an internal address converted by said address converting means, reads contents from a corresponding storage area of said storage device.

11. The shared cache server according to claim 10, further comprising a tag inserting means to convert said internal address to a tag corresponding to said group and to insert said tag into said Uniform Resource Locator and wherein said cache means designates contents based on said Uniform Resource Locator into which said tag is inserted.

12. The shared cache server according to claim 11, wherein said tag inserting means converts, for a packet with a specified Uniform Resource Locator designated, said internal address to a specified tag being used commonly in said group.

13. The shared cache server according to claim 10, further comprising a storage capacity managing means to manage storage capacity in a storage area in every said group.

14. The shared cache server according to claim 13, wherein said storage capacity managing means dynamically manages said storage area in every said group.

15. The shared cache server according to claim 10, further comprising a Domain Name System (DNS) proxy means to designate a server in which contents are stored when contents designated by said packet are not stored in said storage device.

16. The shared cache server according to claim 10, wherein said plurality of virtual networks each being placed in a virtually partitioned manner is constructed in accordance with IEEA 802. 1 Q.

17. The shared cache server according to claim 10, wherein said plurality of virtual networks each being placed in a virtually partitioned manner is constructed in accordance with MPLS Multi Protocol Label Switching (MPLS) technology.

18. A shared cache server being placed on a common network connected to a plurality of groups each having an Internet Protocol address range to be used being different from one another, comprising:
a storage device to store contents in each of a plurality of storage areas corresponding to said plurality of groups; and
a cache means to convert, when receiving a packet requesting for contents with a Uniform Resource Locator (URL) designated, part of an Internet Protocol (IP) address contained in said packet to a tag corresponding to said group and to insert said tag into said Uniform Resource Locator (URL) and to read contents from a storage area of said storage device based on said Uniform Resource Locator (URL) into which said tag has been inserted.
